(19) United States
(12) Patent Application Publication
(10) Pub. No.: US 2024/0117817 A1
(43) Pub. Date: Apr. 11, 2024

(54) IMPELLER MACHINE

(71) Applicant: MDGROUP GERMANY GMBH, Siegen (DE)

(72) Inventor: Daniel Schübeler, Siegen (DE)

(21) Appl. No.: 18/257,704

(22) PCT Filed: Dec. 14, 2021
(86) PCT No.: PCT/EP2021/085702

§ 371 Date: Jun. 15, 2023

(30) Foreign Application Priority Data
Dec. 17, 2020 (EP) 20215021.5

(51) Int. Cl. F04D 29/58; F04D 25/06; F04D 25/08; F04D 29/44; H02K 5/18; H02K 9/06

(52) U.S. Cl. CPC F04D 29/584; F04D 25/06; F04D 25/08; F04D 29/441; H02K 5/18; H02K 9/06

(57) ABSTRACT

An impeller machine having an impeller housing (15), having a motor housing (19) and having an aero stator (20) which extends between the impeller housing (15) and the motor housing (19), wherein the motor housing (19) is arranged in an interior of the impeller housing (15). The impeller machine comprises an aero rotor (14) for generating an air flow along an annular space (31) enclosed between the impeller housing (15) and the motor housing (19). The motor housing (19) is provided on its outer side with a cooling rib (21) which rises from the motor housing (19) and from a peripheral end. A portion (36) of the cooling rib (21) that is arranged upstream is arranged in a different circumferential position than a portion (37) of the cooling rib (21) that is arranged downstream.

### BACKGROUND

The invention relates to an impeller machine having an impeller housing, having a motor housing and having an aero stator which extends between the impeller housing and the motor housing. The motor housing is arranged in an interior of the impeller housing. The impeller machine comprises an aero rotor for generating an airflow along an annular space enclosed between the impeller housing and the motor housing.

A considerable amount of heat is generated during the operation of an impeller machine. If, for example, 5-10% of the drive power of an impeller machine with an output in the order of a few kilowatts is converted into heat, components of the impeller machine may overheat if the heat is not sufficiently dissipated.

### SUMMARY

The invention addresses the problem of presenting an impeller machine with improved heat dissipation. The problem is solved by the features of the independent claim. Advantageous embodiments are described in the dependent claims.

In the impeller machine according to the invention, the outer side of the motor housing is provided with a cooling rib which rises from the motor housing to a peripheral end. An upstream portion of the cooling rib is arranged in a different peripheral position than a downstream portion of the cooling rib.

The invention has recognized that the cooling effect of a cooling rib improves when the cooling rib does not extend parallel to the axial direction of the impeller machine, but has a course on the outer side of the motor housing in which the peripheral position of the cooling rib changes with the course of the cooling rib.

It is advantageous for the cooling effect if the cooling rib has a large length. The cooling rib can extend in the axial direction over at least 60%, preferably at least 80%, more preferably at least 90% of the length of the motor housing. In one embodiment, the upstream end of the cooling rib coincides with the upstream end of the motor housing. The downstream end of the cooling rib may coincide with the downstream end of the motor housing. The motor housing is the component that surrounds the motor and in which the motor is held. A housing cover, if provided, adjoining the motor housing is a separate component from the motor housing.

The height of the cooling rib corresponds to the distance between a foot of the cooling rib and a peripheral end of the cooling rib. The peripheral end is a free end of the cooling rib that is not connected to the impeller housing and is spaced apart from the impeller housing. Thus, the cooling rib does not form a connection between the motor housing and the impeller housing. The line of connection between the peripheral end and the base of the cooling rib, arranged with respect to a given axial position of the impeller machine, may extend in the radial direction of the impeller machine. In other words, the cooling rib is perpendicular to the outer side of the motor housing and extends straight outward from there. This can apply to all axial positions of the cooling rib.

An impeller machine in the sense of the invention is an axial turbomachine. The airflow driven by the aero rotor has a flow direction which is parallel to the axis of the aero rotor. The aero rotor has rotor blades arranged in the same radial portion with respect to the axis as the annular space arranged between the impeller housing and the motor housing.

The distinction between impeller machines and other types of turbomachinery is made on the basis of the Cordier diagram shown in FIG. 8, in which the speed number σ is plotted against the diameter number δ. The impeller machines according to the invention differ from radial and turbomachines by a higher value for the speed number σ and by a lower value for the diameter number δ. The impeller machines according to the invention differ from casing-free propeller machines by a lower value for the speed number σ as well as by a higher value for the diameter number δ. The speed number σ of the impeller machine according to the invention can be between 1.8 and 10. The diameter number δ of the impeller machine according to the invention can be between 0.8 and 1.5.

The speed number σ used in the Cordier diagram is a dimensionless characteristic value defined as follows.

$$σ = 2 \sqrt{π} n \frac{\sqrt{Q}}{{( 2 Y )}^{3 / 2}}$$

The diameter number δ is also a dimensionless characteristic value defined as follows.

$$δ = \frac{\sqrt{π}}{2} D \sqrt[4]{\frac{2 Y}{{Q}^{2}}}$$

Both formulas take into account the volume flow Q and the head coefficient Y (specific head). Considering these two variables as given by the intended use of the turbomachine, the speed number σ depends only on the speed n and the diameter number δ only on the diameter D of the aero rotor. More detailed explanations can be found, for example, in Epple et al, A theoretical derivation of the Cordier diagram for turbomachines, Proceedings of the Institution of Mechanical Engineers, Part C: Journal of Mechanical Engineering Science 2011 225: 354.

The annular space enclosed between the impeller housing and the motor housing can have a portion with a constant cross-section. The portion may extend over at least 50%, preferably at least 70%, more preferably at least 80% of the axial length of the annular space. Constant cross-section means that the distance between the inner side of the impeller housing and the outer side of the motor housing is constant and that the outer diameter and inner diameter of the annular space are constant. Aero stators and/or cooling ribs within the annular space are not considered as a change in cross-section for this purpose. The aero rotor may have rotor blades that cover the constant cross-section of the annular space when viewed in the radial direction of the impeller machine.

The impeller machine may comprise a component in which the motor housing and the cooling ribs are connected to one another in one piece. The component may be, for example, a casting, a 3D printed part or a milled part.

The motor housing may be substantially cylindrical in shape. The height of the cooling rib between the outer side of the motor housing and the peripheral end of the cooling rib may be between 2% and 20%, preferably between 5% and 15%, relative to the diameter of the motor housing. Relative to the radial extent of the annular space between the inner side of the impeller housing and the outer side of the motor housing, the height of the cooling rib may be between 2% and 20%, preferably between 5% and 15%. It is true that the cooling effect could possibly be further improved with a greater height of the cooling rib. However, the cooling rib also puts up resistance to the air flow, so that, the greater the height of the cooling rib, the lower the efficiency of the impeller machine. If the diameter of the motor housing changes over the length of the impeller machine, the specification refers to the largest diameter of the motor housing. If the radial extent of the annular space changes over the length of the impeller machine, the specification refers to the largest radial extent of the annular space. The cooling rib may have a constant height over its length. If the height of the cooling rib changes over the length of the impeller machine, the specification refers to the greatest height of the cooling rib.

The course of the cooling rib along the outer side of the motor housing may be a non-linear course. An upstream portion of the cooling rib may form a greater angle with a longitudinal line than a downstream portion of the cooling rib. A longitudinal line is defined as a line extending on the outer side of the motor housing along the length of the motor housing such that there is a plane in which both the axis of the impeller machine and the longitudinal line are located. For the purposes of the invention, a longitudinal line has a constant peripheral position.

The upstream end of the cooling rib may form an angle of more than 10°, for example an angle between 10° and 50°, preferably an angle between 20° and 40° with the longitudinal line. The downstream end of the cooling rib may form an angle of less than 8°, preferably an angle of less than 5°, with the longitudinal line. Preferably, the downstream end of the cooling rib forms an angle of more than 0° with the longitudinal direction, for example an angle between 1° and 5°. In one embodiment, the downstream end of the cooling rib is oriented parallel to the longitudinal line. A portion of the cooling rib parallel to the longitudinal line preferably constitutes less than 20%, preferably less than 10%, further preferably less than 5% of the length of the cooling rib. The cooling rib may have a continuous curvature. The curvature may be such that the angle between the cooling rib and the longitudinal line continuously decreases from the upstream end to the downstream end of the cooling rib. The continuous curvature may extend over at least 70%, preferably at least 80%, more preferably at least 90% of the length of the cooling rib. The cooling rib may be configured such that there is no longitudinal line that is intersected twice by the cooling rib.

A motor which drives a shaft connected to the aero rotor may be arranged in the interior of the motor housing. The aero rotor drives the airflow through the annular space between the motor housing and the impeller housing, wherein the direction of movement of the airflow delivered by the aero rotor has a component in the axial direction and a component in the peripheral direction. The upstream end of the cooling rib may be oriented such that the airflow enters the annular space substantially parallel to the end of the cooling rib. The cooling rib, with its curved shape along the annular space, can help guide the airflow so that it is directed substantially in the axial direction as it exits the annular space. The aero rotor arranged upstream of the motor housing may be located inside the impeller housing.

The downstream end of the motor housing may extend rearwardly beyond the downstream end of the impeller housing. The cooling rib may comprise a downstream portion that is outside the annular space surrounded by the impeller housing. This has the advantage that the airflow in the region of the motor housing is still subject to guidance as it passes from the annular space to the surrounding area.

The impeller machine may comprise a plurality of cooling ribs having the stated features. A cooling channel open to one side may be formed between two adjacent cooling ribs. The cooling ribs may be distributed around the periphery of the motor housing. The cooling ribs from the plurality of cooling ribs may be shaped conformably. Two cooling ribs are shaped conformably if they can be mapped into each other by rotating the impeller machine about its central axis. The lateral distance between two cooling ribs can be between 25% and 200% of the height of the cooling ribs.

The impeller machine may have an aero stator which extends between the impeller housing and the motor housing and holds the motor housing in position relative to the impeller housing. The aero stators may extend along a curved path such that an upstream end of the aero stator forms a greater angle with the longitudinal line than a downstream end of the aero stator. The aero stator may form an airfoil profile that is effective with respect to the airflow passing through the annular space. The impeller machine may be provided with a plurality of such aero stators, such as three aero stators. The aero stators may be equally distributed over the periphery of the motor housing.

At least one cooling rib can be arranged between each two adjacent aero stators. Preferably, a plurality of cooling ribs is arranged between every two adjacent aero stators, for example at least three cooling ribs, preferably at least five cooling ribs, further preferably at least eight cooling ribs. This may apply to any pair of adjacent aero stators.

To further improve cooling, the impeller machine may comprise a cooling air channel which extends through the interior of the motor housing. The cooling air channel may have an inlet opening arranged at a downstream end of the motor housing. The cooling air channel may have an outlet opening arranged upstream of the inlet opening. The outlet opening may extend through the wall of the motor housing and open out into the annular space. The distance between the outlet opening and the inlet opening may be greater, preferably at least twice the distance between the outlet opening and the aero rotor. The impeller machine may have a plurality of such cooling air channels.

The outlet opening of the cooling air channel may open out in a region of the annular space in which a negative pressure which is lower than the pressure at the inlet opening is present during operation of the impeller machine. This makes it possible to drive a cooling air flow along the cooling air channel by a pressure difference between the inlet opening and the outlet opening.

The negative pressure in the annular space may result from the air flow having a higher velocity on one side of the aero stator than on the other side of the aero stator. The outlet opening of the cooling air channel may be located adjacent to the negative pressure side of an aero stator. The distance between the outlet opening and the positive pressure side of the nearest aero stator may be at least twice as large, preferably at least three times as large, as the distance between the outlet opening and the negative pressure side of the adjacent aero stator. It is also possible that the aero stator has a cavity in its interior connected to the interior of the motor housing and that the outlet opening is arranged in a wall of the aero stator facing the negative pressure side.

Alternatively, the cooling ribs according to the invention can also be attached to a motor housing, the interior of which is free of a cooling channel. In particular, the impeller machine may comprise a motor housing, of which the interior is sealed dust-tightly and/or water-tightly. In this way, effective cooling can also be achieved for impeller machines which are used in adverse ambient conditions and for which internal cooling must therefore be dispensed with.

An electrically driven motor may be arranged inside the motor housing. The electric motor may be supplied with electric power from a power source arranged outside the impeller machine. The motor may drive a motor shaft which extends in the axial direction of the impeller machine. An aero rotor may be connected to the motor shaft and rotated with the motor shaft. The aero rotor may comprise rotor blades which extend outwardly substantially in a radial direction. The rotor blades may be arranged and dimensioned to sweep the radial portion spanned by the annular space between the impeller housing and the motor housing.

The aero rotor may be arranged in an upstream portion of the annular space so that the airflow driven by the aero rotor passes first through the aero rotor and then through the longer portion of the annular space. The upstream end of the impeller machine is referred to as the front end, and the downstream end of the impeller machine is referred to as the rear end. The impeller housing may form a closed envelope which extends peripherally around the annular space. An upstream portion of the impeller housing may be arranged radially outside the aero rotor so that the aero rotor is arranged in the interior of the impeller housing.

The impeller machine may comprise an aero stator that holds the motor housing relative to the impeller housing. A cable may be routed inside the aero stator. The cable may be a supply cable via which electrical power is supplied to the motor of the impeller machine. The cable may also be a sensor cable or a control cable used to transmit signals between the interior of the motor housing and the exterior of the impeller housing.

The impeller machine may comprise a plurality of aero stators which extend between the impeller housing and the motor housing. The plurality of aero stators may be arranged in the same axial position. The positions of the aero stators may be equally distributed with respect to the periphery of the impeller machine. For example, three aero stators may be distributed over the periphery of the impeller machine. The aero stators may have an airfoil profile in order to guide and straighten the airflow generated by the aero rotor.

The annular space may have an axial extent which extends from the plane of the aero stator to a downstream end of the impeller housing. The aero stators may extend rearwardly beyond the impeller housing with their rear end. A front portion of the aero stator may be arranged in the interior of the impeller housing.

### BRIEF DESCRIPTION OF THE DRAWINGS

The invention is described below by way of example with reference to the accompanying drawings on the basis of advantageous embodiments, in which:

FIG. 1: shows an impeller machine according to the invention;

FIG. 2: shows a schematic sectional view of the impeller machine from FIG. 1;

FIG. 3: shows a schematic view of a cooling rib of an impeller machine according to the invention;

FIG. 4: shows a simplified sectional view of a motor housing according to the invention;

FIG. 5: shows an alternative embodiment of an impeller machine according to the invention in a partially disassembled state;

FIG. 6: shows the impeller machine from FIG. 5 in the assembled state;

FIG. 7: shows a schematic view of an aero stator of an impeller machine according to the invention; and

FIG. 8: shows a Cordier diagram to distinguish different types of turbomachinery.

### DETAILED DESCRIPTION

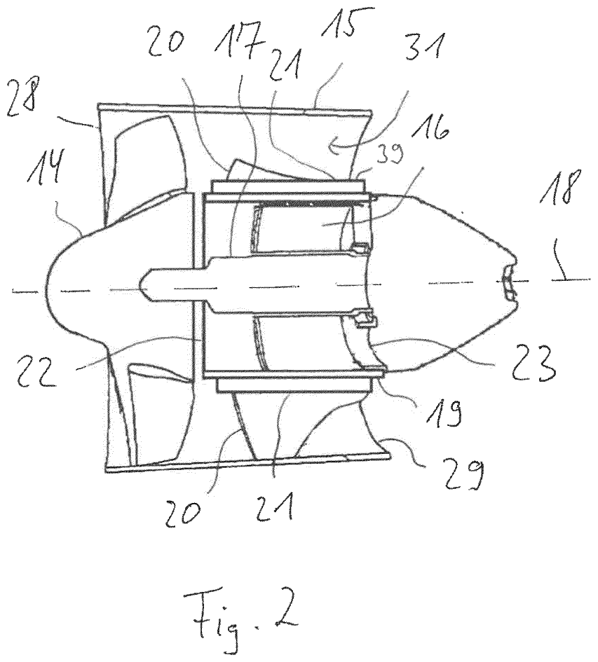

According to FIG. 2, an impeller machine according to the invention comprises an aero rotor 14 arranged in an impeller housing 15. An electric motor 16 drives a shaft 17 so that the aero rotor 14 connected to the shaft 17 is made to rotate. The shaft 17 extends along a central axis 18 of the impeller machine. The motor 16 is held in a motor housing 19 arranged in the interior of the impeller housing 15.

An impeller machine in the sense of the invention is an axial turbomachine with high efficiency, which in the Cordier diagram (FIG. 8) has a speed number σ between 1.8 and 10 and a diameter number δ between 0.8 and 1.5. The impeller machine according to the invention differs from radial turbomachines with high efficiency by a higher value for the speed number σ and a lower value for the diameter number δ. The impeller machine according to the invention differs from casing-free propeller machines by a lower value for speed number σ and a higher value for diameter number δ. A plurality of aero stators 20, by means of which the motor housing 19 is held in position relative to the impeller housing 15, are formed in an annular space 31 enclosed radially outside the motor housing 19 and radially inside the impeller housing 15. The aero rotor 14 comprises a plurality of rotor blades that rotate at an upstream end of the annular space 31. Rotation of the aero rotor 14 generates an airflow that extends from the aero rotor 14 through the annular space 31 to the opposite, downstream end of the impeller machine. The upstream end is the front end of the impeller machine, and the downstream end is the rear end of the impeller machine.

The front end 28 of the impeller housing 15 is located further upstream than the front end 22 of the motor housing 19. The impeller housing 15 surrounds the aero rotor 14 located upstream of the motor housing 19 so that the aero rotor rotates in the interior of the impeller housing 15.

The rear end 23 of the motor housing 19 is located further downstream than the rear end of the impeller housing 29. In this way, the motor housing 19 comprises a rear portion that extends rearwardly beyond the impeller housing 15.

Cooling ribs 21 are formed on the outer side of the motor housing 19 and rise from the motor housing 19 to a peripheral end 39 and extend longitudinally between the front end 22 and the rear end 23 of the motor housing. In FIG. 2, the cooling ribs 21 are only schematically indicated. The airflow in the annular space 31 sweeps over the surface of the cooling ribs 21 and dissipates heat from cooling ribs 21. The heat emitted by the motor during operation of the impeller machine spreads through the motor housing 19 to the cooling ribs 21 and is absorbed there by the airflow.

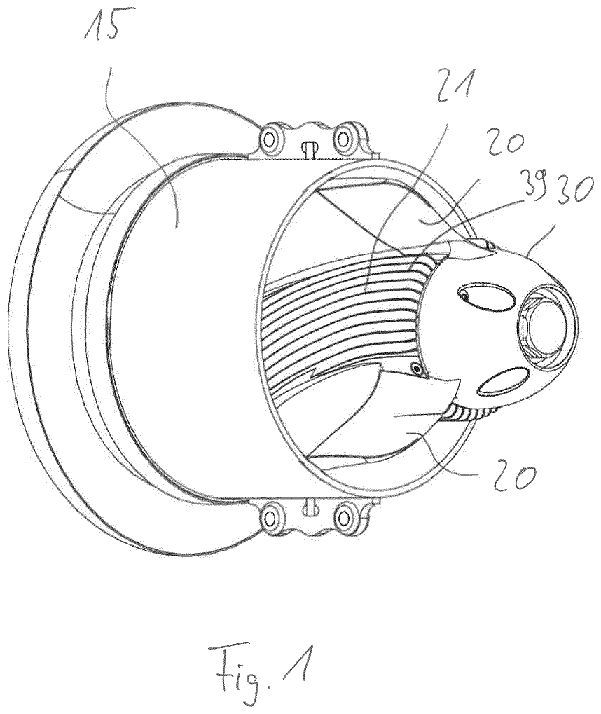

A plurality of cooling ribs 21 is formed between each two adjacent aero stators 20. In the exemplary embodiment according to FIG. 1, eleven cooling ribs are arranged between the two aero stators 20 visible in the figure. With a total of three aero stators 20, this results in thirty-three cooling ribs 21 distributed over the periphery of the motor housing 19. The cooling ribs 21 are identically shaped and have a constant spacing from one another, so that a cooling channel open to one side and having a substantially constant cross-section extends between each two cooling ribs 21. The air flow can follow the cooling channels without causing any major turbulence.

Viewed longitudinally, a larger portion of the cooling ribs 21 is located within the annular space 31 between the impeller housing 15 and the motor housing 19. A shorter portion of the cooling ribs 21 protrudes rearward from the annular space 31. The cooling ribs 21 terminate with the rear end of the motor housing 19. A housing cover 30 adjoins the rear end of the motor housing 19 and covers the motor towards the rear.

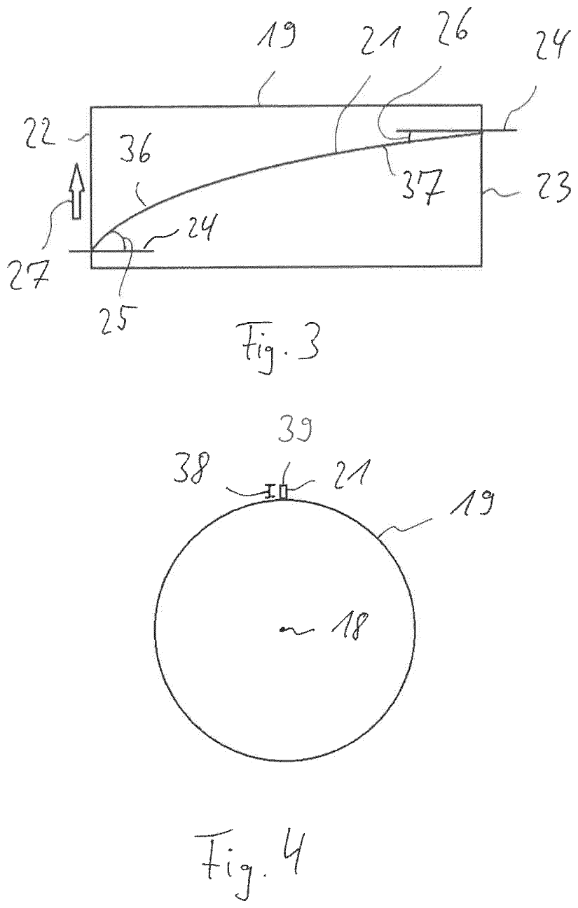

The cooling ribs 21 extend longitudinally along a curved path from the front end 22 to the rear end 23 of the motor housing 19. According to the schematic depiction in FIG. 3, the longitudinal direction of the cooling rib 21 forms an angle 25 of approximately 45° with the longitudinal line 24 at the front end 22 of the motor housing 19. The angle between the longitudinal direction of the cooling rib 21 and the longitudinal line 24 becomes continuously smaller with increasing distance from the front end 22 of the motor housing 19. At the rear end 23 of the motor housing 19, the angle between the longitudinal direction of the cooling rib 21 and the longitudinal line 24 is still about 5°.

The arrow 27 indicates the direction of rotation with which the aero rotor 14 passes this peripheral portion of the motor housing 19. The angle between the longitudinal direction of the cooling rib 21 at the front end 22 of the motor housing 19 and the direction of movement of a part of the aero rotor 14 adjacent thereto is less than 90°.

Viewed in cross-section, the cooling ribs 21 are substantially rectangular as shown in the schematic depiction in FIG. 4. The cooling ribs 21 have a substantially constant cross-section along their length. The cooling ribs 21 form a right angle with the surface of the motor housing 19. The cooling ribs 21 rise from the outer side of the motor housing 19 to a free end 39.

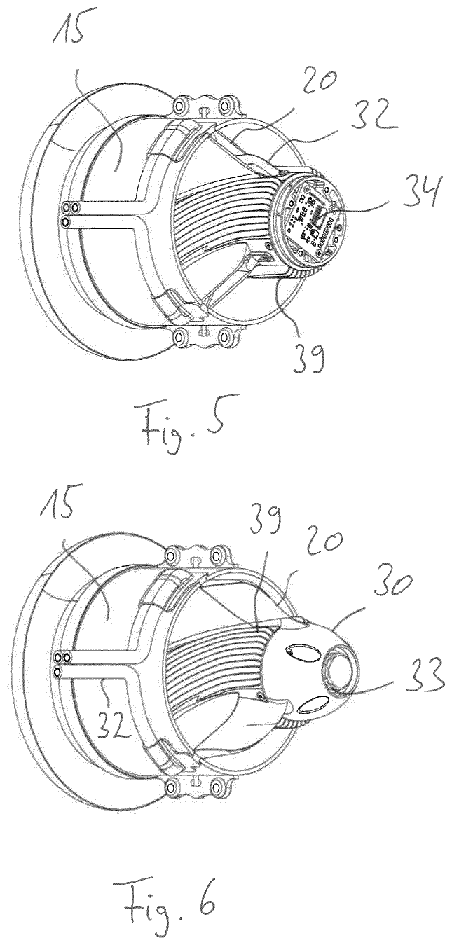

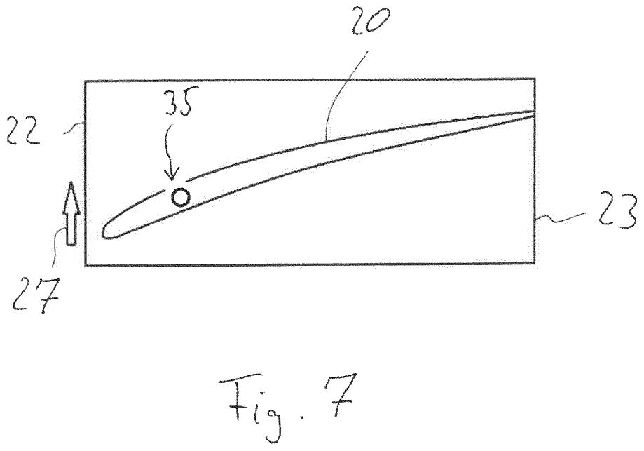

In the embodiment according to FIGS. 5 and 6, the aero stators 20 each have, in the interior, a cavity which is open towards the rear end. The cavity extends over the entire radial extent of the annular space 31. Cables 32 are guided in the cavity and extend from the interior of the motor housing 19 to the exterior of the impeller housing 15. The cables 32 comprise supply lines, by means of which electrical power from a battery arranged outside the impeller machine is supplied to the electric motor 16 in the motor housing 19. The cables 32 may further comprise control lines and/or sensor lines, by which signals are transmitted during operation of the impeller machine. At the rear end of the motor housing 19, there is arranged a control board 34, via which the motor 16 is controlled. By routing the cables 32 within the aero stators 20, it is possible to avoid the air flow between the cooling ribs 21 being impaired by cables.

After inserting the cables 32, the aero stators 20 are covered towards the rear with a housing cover 30. The housing cover 30 is flush with the body of the aero stators 20 and continues the contour of the aero stators 20 to the rear. This condition of the impeller machine is shown in FIG. 6.

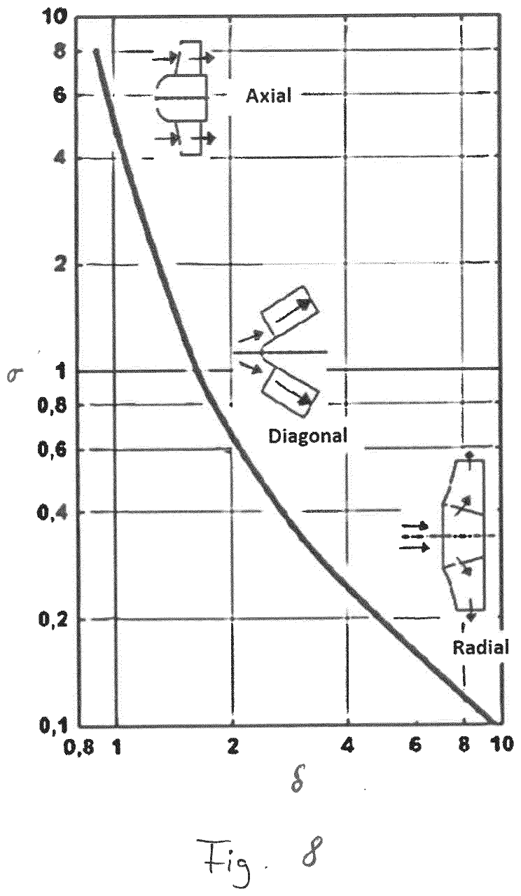

At the rear end, the housing cover 30 is provided with an inlet opening 33 of a cooling air channel. The cooling air channel extends from the inlet opening 33 through the interior of the motor housing 19 to an outlet opening 35 in the annular space 31. The outlet opening 35 extends through the wall of the motor housing 19 and opens out in a region in which a negative pressure is present during operation of the impeller machine 19. In the schematic depiction according to FIG. 7, the outlet opening 35 of the cooling air channel is arranged on the negative pressure side of an aero stator 20. The outlet opening 35 formed in the wall of the aero stator is connected to a cavity in the interior of the aero stator 20, which in turn is connected to the interior of the motor housing 19. When a negative pressure is present at the outlet opening 35, while substantially atmospheric pressure prevails in the region of the inlet opening 33, a cooling air flow is generated through the cooling air channel as a result of the pressure difference during operation of the impeller machine.

For effective internal cooling of the electric motor 16, the impeller machine comprises a plurality of outlet openings 35. An outlet opening 35 is associated with each of the three aero stators 20, wherein the outlet opening 35 is arranged in each case on the negative pressure side of the aero stator 20. The cooling air at the rear end of the impeller machine can enter via one or more inlet openings 33.

For the assembly of the impeller machine according to the invention, the impeller housing 15 and the motor housing 19 connected thereto via the aero stators 20 are provided as a unitary component. The cooling ribs 21 on the outer side of the motor housing 19 are a part of the unitary component. The motor housing 19 has, in its interior, a space intended for receiving the electric motor 16. The electric motor 16 with the cables 32 and the control board 34 is brought up to the motor housing 19 from behind and is pushed into the motor housing 19. During insertion, the cables 32 are inserted into the cavities of the aero stators 20 accessible from the rear. The cables 32 are fixed in their position with adhesive.

When the electric motor 16 has reached its final position in the motor housing 19 and rests against a stop of the motor housing 19, the aero rotor 14 is placed on the shaft 17 of the electric motor 16 from the front and screwed to the shaft 17.

The cover component 38 is then placed on the motor housing 19 from behind and screwed to the motor housing 19. This step also closes the cavities of the aero stators 20 so that the cables 32 are arranged in a cavity that is closed off all around.

1. An impeller machine comprising an impeller housing (15), a motor housing (19) and an aero stator (20) which extends between the impeller housing (15) and the motor housing (19), wherein the motor housing (19) is arranged in an interior of the impeller housing (15), said impeller machine comprising an aero rotor (14) for generating an airflow along an annular space (31) enclosed between the impeller housing (15) and the motor housing (19), wherein the motor housing (19) is provided on its outer side with a cooling rib (21), wherein the cooling rib (21) rises from the motor housing (19) to a peripheral end (39), and wherein an upstream portion (36) of the cooling rib (21) is arranged in a different peripheral position than a downstream portion (37) of the cooling rib (21).

2. The impeller machine of claim 1, wherein the cooling rib (21) extends in an axial direction (18) over at least 60% of a length of the motor housing (19).

3. The impeller machine of claim 1, wherein a height (38) of the cooling rib (21) between an outer side of the motor housing (19) and the peripheral end (39) is between 2% and 20% of a diameter of the motor housing (19).

4. The impeller machine of claim 1, wherein a height (38) of the cooling rib (21) between an outer side of the motor housing (19) and the peripheral end (39) is between 2% and 20% of a radial extent of the annular space (31) between an inner side of the impeller housing (15) and an outer side of the motor housing (19).

5. The impeller machine of claim 1, wherein an angle (25) that the upstream portion (36) of the cooling rib (21) forms with a longitudinal line (24) is greater than an angle (24) that the downstream portion (37) of the cooling rib (21) forms with a longitudinal line (24).

6. The impeller machine of claim 1, wherein an upstream end of the cooling rib (21) forms an angle (25) between 10° and 50° with a longitudinal line (24).

7. The impeller machine of claim 1, wherein a downstream end of the cooling rib (21) forms an angle (26) of less than 8° with a longitudinal line (24).

8. The impeller machine of claim 1, wherein an angle (25, 26) between the cooling rib (21) and a longitudinal line (24) continuously decreases from an upstream end to a downstream end of the cooling rib (21).

9. The impeller machine of claim 1, wherein the downstream portion (37) of the cooling rib (21) extends rearwardly beyond a downstream end of the impeller housing and is located outside the annular space (31) surrounded by the impeller housing (15).

10. The impeller machine of claim 1, comprising a plurality of cooling ribs (21) distributed over a periphery of the motor housing (19).

11. The impeller machine of claim 1, comprising a cooling air channel which extends through an interior of the motor housing (19).

12. The impeller machine as of claim 11, wherein an outlet opening (35) of the cooling air channel opens out in a region of the annular space in which a negative pressure is present during operation of the impeller machine.

13. The impeller machine of claim 1, wherein an interior of the motor housing (19) is sealed dust-tightly and/or or water-tightly.

14. The impeller machine of claim 1, wherein the aero stator (20) holds the motor housing (19) relative to the impeller housing (15), and a cable is routed inside the aero stator.
